(19) United States
(12) Patent Application Publication
(10) Pub. No.: US 2020/0122538 A1
(43) Pub. Date: Apr. 23, 2020

(54) RIDE CONTROL SYSTEMS AND METHODS FOR ROTARY CUTTING MACHINES

(71) Applicant: Caterpillar Paving Products Inc., Brooklyn Park, MN (US)

(72) Inventors: Eric S. Engelmann, Delano, MN (US); Conwell K. Rife, JR., Wayzata, MN (US)

(73) Assignee: Caterpillar Paving Products Inc., Brooklyn Park, MN (US)

(21) Appl. No.: 16/658,996

(22) Filed: Oct. 21, 2019

Related U.S. Application Data
(60) Provisional application No. 62/749,551, filed on Oct. 23, 2018.

(51) Int. Cl. B60G 17/00; B62D 55/084; F15B 19/00; F15B 11/20

(52) U.S. Cl. CPC B60G 17/00; B62D 55/084; E01C 23/088; F15B 11/20; F15B 19/00

(57) ABSTRACT

A hydraulic circuit for a lifting system of a propulsion system for a construction machine having multiple independent propulsors can comprise a plurality of hydraulic cylinders each comprising a piston and a rod for coupling to a propulsor, a plurality of fluid lines coupling each of the plurality of hydraulic cylinders in series, wherein movement of one piston hydraulically causes movement of a subsequent piston in an opposite direction, and a plurality of flow control devices positioned within the plurality of fluid lines such that a flow control device is positioned between adjacent hydraulic cylinders, each flow control device comprising an intermediate body configured to smooth flow of hydraulic fluid between adjacent hydraulic cylinders without directly coupling one cylinder to another.

### CLAIM OF PRIORITY

This application claims the benefit of priority to U.S. Provisional Application Ser. No. 62/749,551, filed on Oct. 23, 2018, which is incorporated herein by reference in its entirety.

### TECHNICAL FIELD

The present application relates generally, but not by way of limitation, to ride control systems and methods for machines that can be used to remove or recycle paved surfaces, such as cold planer machines and rotary mixer machines. More particularly, but not by way of limitation, the present application relates to systems and methods used to control and adjust movement of multi-legged propulsors for such machines.

### BACKGROUND

Cold planer machines and rotary mixer machines can be used to mill or grind-up old or degraded pavement from surfaces such as roadways and parking lots. Cold planers can be configured to remove the pavement for transportation away from the surface, while rotary mixers can be configured to reconstitute or recycle the pavement for reuse at the surface. The surfaces can extend over uneven terrain. As such, these machines can include systems for adjusting the vertical height of the machine and a rotary cutting tool attached thereto in order to, for example, control the cutting depth and provide a smooth ride for the operator.

U.S. Pat. No. 7,828,309 to Berning et al., entitled “Road-Building Machine,” discloses “a road-building machine, in particular a road-milling machine, a recycler or a stabilizer, of which the left front wheel or caterpillar, right front wheel or caterpillar, left rear wheel or caterpillar and right rear wheel or caterpillar is adjustable in height by means of an actuating member.”

### BRIEF DESCRIPTION OF THE DRAWINGS

FIG. 1 is a schematic side view of a cold planer machine showing a milling system, an anti-slabbing system, a conveyor system and a plurality of transportation devices mounted to lifting columns.

FIG. 2 is a diagrammatic top view of front left, front right, rear left and rear right transportation devices connected to lifting columns that are operatively connected to a hydraulic system including intermediate elements comprising free-floating pistons.

FIG. 3 is a diagrammatic top view of front left, front right, rear left and rear right transportation devices connected to lifting columns that are operatively connected to a hydraulic system including intermediate elements comprising gas-compressing pistons.

FIG. 4 is a diagrammatic view of another embodiment of an intermediate element for use in a fluid line connecting two lifting columns comprising a dual-diameter cylinder device.

FIG. 5 is a diagrammatic top view of the front left, front right, rear left and rear right transportation devices connected to lifting columns that are operatively connected to a hydraulic system including intermediate elements comprising gas-compressing pistons of FIG. 3 and further comprising a control valve system fluidly connecting ends of the lifting columns.

FIG. 6 is a diagrammatic view of an example of a portion of the control valve system of FIG. 5 wherein the control valve is configured to route hydraulic fluid from an isolated source to opposite ends of pistons of individual lifting columns.

FIG. 7 is a diagrammatic top view of front left, front right, rear left and rear right transportation devices connected to lifting columns that are operatively connected to a hydraulic system including intermediate elements of FIG. 4 and a control valve system fluidly connecting ends of the lifting columns.

FIG. 8 is a schematic diagram of a control system for the cold planer machine of FIG. 1 illustrating a controller in communication with lifting column sensors, a hydraulic system and auxiliary sensors.

### BRIEF SUMMARY

In an example, a hydraulic circuit for a lifting system of a propulsion system for a construction machine having multiple independent propulsors can comprise a plurality of hydraulic cylinders each comprising a piston and a rod for coupling to a propulsor, a plurality of fluid lines coupling each of the plurality of hydraulic cylinders in series, wherein movement of one piston hydraulically causes movement of a subsequent piston in an opposite direction, and a plurality of flow control devices positioned within the plurality of fluid lines such that a flow control device is positioned between adjacent hydraulic cylinders, each flow control device comprising an intermediate body configured to smooth flow of hydraulic fluid between adjacent hydraulic cylinders without directly coupling one cylinder to another.

In another example, a method of smoothing movement between adjacent hydraulic cylinders in a hydraulic circuit for a lifting system of a propulsion system for a construction machine having multiple independent propulsors can comprise displacing a first piston of a first hydraulic cylinder of the lifting system due to impacting an obstacle by a first propulsor coupled to the first hydraulic cylinder, transferring force from a first hydraulic fluid from the first hydraulic cylinder in a first fluid line to a second hydraulic fluid of a second hydraulic cylinder in a second fluid line, and smoothing force transfer between the first hydraulic cylinder and the second hydraulic cylinder with an intermediate body disposed between the first fluid line and the second fluid line.

### DETAILED DESCRIPTION

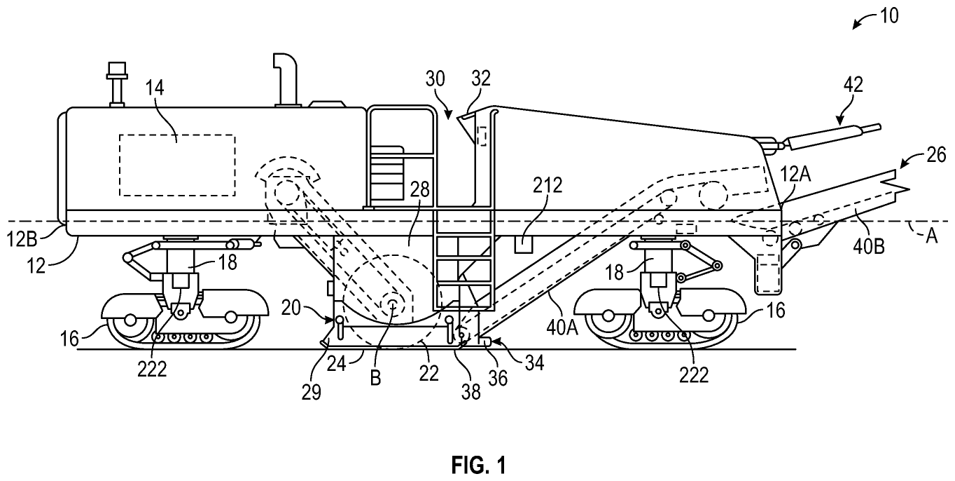

FIG. 1 is a schematic side view of cold planer machine 10 showing frame 12 to which power source 14 and transportation devices 16 can be connected. Transportation devices 16, which, as described below, can comprise wheels or tracks, can be connected to frame 12 via lifting columns 18. Milling assembly 20 can, for example, be coupled to the underside of frame 12 between forward and rear transportation devices 16. Although the present application is described with reference to a cold planer machine including a milling drum and conveyors, the present invention is applicable to other types of machines mounted on individually articulatable propulsion devices, such as rotary mixing machines as further described below.

Frame 12 can longitudinally extend between first end 12A and second end 12B along frame axis A. Power source 14 can be provided in any number of different forms including, but not limited to, internal combustion engines, electric motors, hybrid engines and the like. Power from power source 14 can be transmitted to various components and systems of machine 10, such as transportation devices 16 and milling assembly 20.

Frame 12 can be supported by transportation devices 16 via lifting columns 18. Transportation devices 16 can be any kind of ground-engaging device that allows cold planer machine 10 to move over a ground surface such as a paved road or a ground already processed by cold planer machine 10. Transportation devices 16 can comprise metal chain-link tracks, rubber tracks, pneumatic tires and the like. For example, in the illustrated embodiment, transportation devices 16 are configured as endless-track assemblies or crawlers. However, in other examples, transportation devices 16 can be configured as wheels, such as inflatable rubber tires and hard tires. Transportation devices 16 can be configured to move cold planer machine 10 in forward and backward directions along the ground surface in the direction of axis A. Lifting columns 18 can be configured to raise and lower frame 12 relative to transportation devices 16 and the ground. One or more of lifting columns 18 can be configured to rotate along a vertical axis, e.g. perpendicular to axis A, to provide steering for cold planer machine 10.

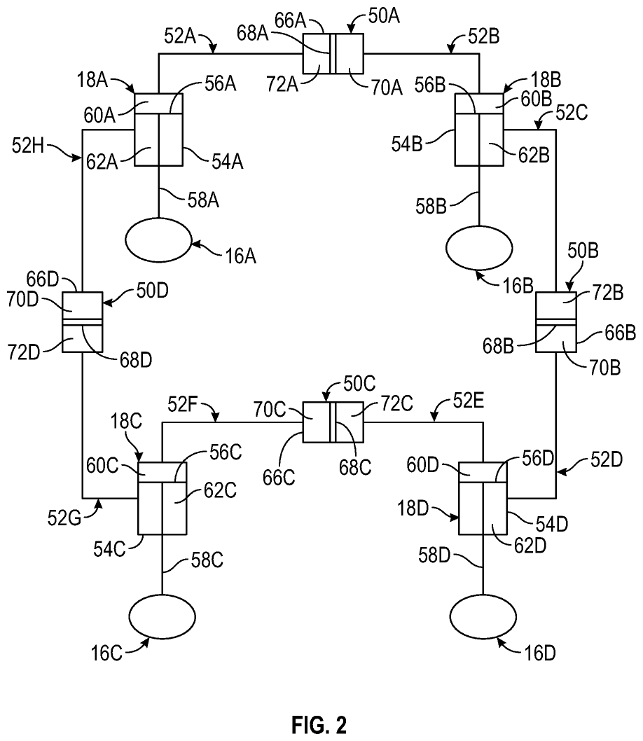

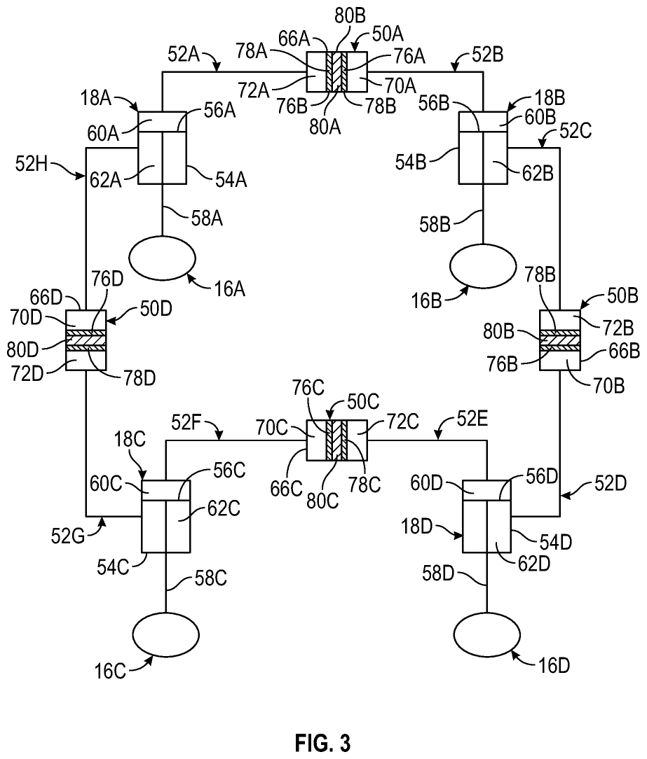

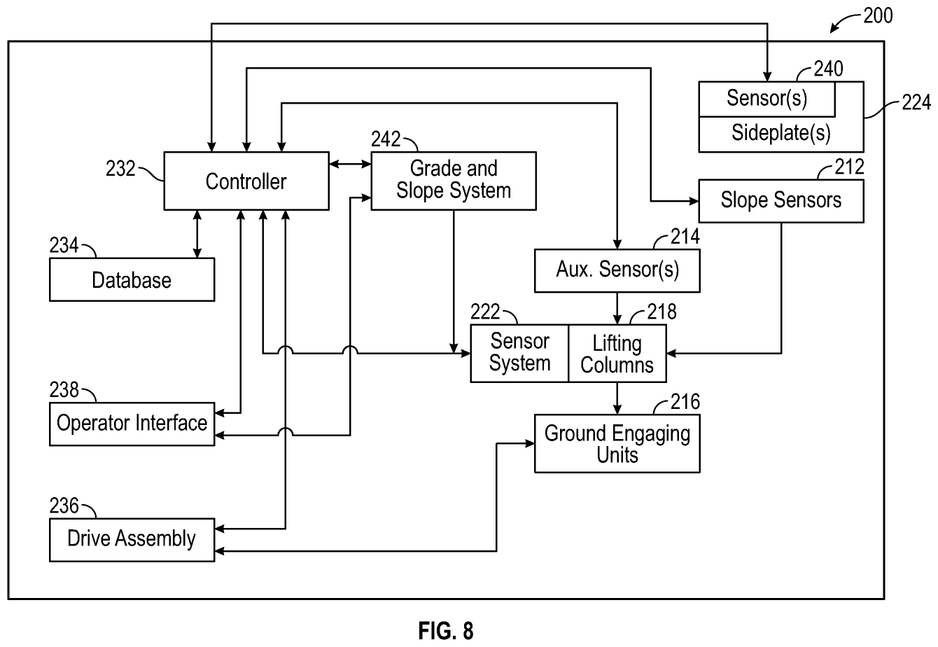

Cold planer machine 10 can comprise four transportation devices 16: a front left transportation device, a front right transportation device, a rear left transportation device and a rear right transportation device, each of which can be connected to a lifting column. That is, additional propulsion devices 16 and lifting columns 18 can be provided adjacent propulsion devices 16 shown in FIG. 1 further into the plane of FIG. 1, as can be seen in FIGS. 2 and 3, etc. Although, the present disclosure is not limited to any particular number of propulsion devices or lifting columns. Lifting columns 18 can be provided to raise and lower frame 12 to, for example, control a cutting depth of rotor 22 and to accommodate cold planer machine 10 engaging obstacles on the ground. As described herein, lifting columns 18 can be coupled to control system 200 (FIG. 8) that operates with a hydraulic system that can include intermediate elements (e.g., flow control devices 50A-50D, intermediate element 90) to smooth out movements of lifting columns 18 to, for example, improve operator experience or adjust the position of milling assembly 20.

Cold planer machine 10 can further include milling assembly 20 connected to frame 12. Milling assembly 20 can comprise rotor 22 operatively connected to power source 14 for rotation. Rotor 22 can comprise a milling drum, cutting drum, cold planning drum, mixing drum or the like. Rotor 22 can include a plurality of cutting tools, such as chisels, disposed thereon. Rotor 22 can be rotated about a drum or housing axis B extending in a direction perpendicular to frame axis A into the plane of FIG. 1. As rotor 22 spins or rotates about drum axis B, the cutting tools can engage work surface 24, which can comprise the ground, dirt, asphalt or concrete for example, of existing work areas, roadways, bridges, parking lots and the like. Moreover, as the cutting tools engage work surface 24, the cutting tools engage layers of materials forming work surface 24, such as hardened dirt, rock or pavement and displace the layers for removal or mixing. The spinning action of rotor 22 and the cutting tools then transfers the material of work surface 24 to conveyor system 26 for operation of cold planer machine 10, or recycle the material back into the work surface.

Milling assembly 20 can further comprise drum housing 28 forming a chamber for accommodating rotor 22. Drum housing 28 can include front and rear walls, and a top cover positioned above rotor 22. Furthermore, drum housing 28 can include lateral covers, or sideplates 29 (see also sideplates 224 of FIG. 8), on the left and right sides of rotor 22 with respect to a travel direction of cold planer machine 10. Drum housing 28 can be open toward the ground so that rotor 22 can engage the ground from drum housing 28. Furthermore, drum housing 28 can be removed from frame 12 for maintenance, repair and transport.

In embodiments applicable to rotary mixers, drum housing 28 can be configured to contain rotor 22 against work surface 24 and form a mixing chamber. As such, rotor 22 can be configured to contact a work surface during travel of the machine to reclaim and/or pulverize the work surface, such as by mixing reclaimed soil or paving material with various additives or aggregates deposited on the work surface. Thus, a rotary mixing machine of the present application can include systems for depositing an additive, such as Portland cement, lime, fly ash, cement kiln dust, etc., on the work surfaces during the reclaiming or pulverizing operations.

Cold planer machine 10 can further include operator station or platform 30 including control panel 32 for inputting commands to control system 200 (FIG. 8) for controlling cold planer machine 10, and for outputting information related to an operation of cold planer machine 10. As such, an operator of cold planer machine 10 can perform control and monitoring functions of cold planer machine 10 from platform 30, such as by observing various data output by sensors located on cold planer machine 10, such as leg position sensors of sensor system 222 (FIG. 8), auxiliary sensor(s) 214 (FIG. 8) and slope sensor 212 (FIG. 8). Furthermore, control panel 32 can include controls for operating transportation devices 16 and lifting columns 18.

Anti-slabbing system 34 can be coupled to drum housing 28 and can include an upwardly oriented base plate (not visible in FIG. 1) extending across a front side of the cutting chamber, a forwardly projecting plow 36 for pushing loose material lying upon work surface 24, and a plurality of skids 38.

Primary conveyor 40A can be positioned forward of rotor 22 and can be coupled to and supported upon the base plate of anti-slabbing system 34. Primary conveyor 40A can feed material cut from work surface 24 via rotor 22 to secondary conveyor 40B projecting forward of frame end 12A. Positioning mechanism 42 can be coupled to secondary conveyor 40B, to enable up and down position control of secondary conveyor 40B. Additional mechanisms can be provided for left and right positioning of secondary conveyor 40B. Secondary conveyor 40B can deposit removed pieces of work surface 24 into a receptacle, such as the box of a dump truck. In other examples, one or more conveyors can be provided at the rear end of machine 10. In other construction machines, such as rotary mixer embodiments, conveyors 40A and 40B can be omitted.

Cold planer machine 10, as well as other exemplary road construction machines such as rotary mixers, can include further components not shown in the drawings, which are not described in further detail herein. For example, cold planer machine 10 can further include a fuel tank, a cooling system, a milling fluid spray system, various kinds of circuitry and computer related hardware, etc.

Cold planer machine 10 can drive over work surface 24 such that front transportation devices 16 roll over work surface 24. Cold planer machine 10 can be configured to remove work surface 24 from a roadway to leave a planed surface behind. Rear transportation devices 16 can roll on the planed surface, with milling assembly 20 producing an edge of the material of work surface 24 between milled and un-milled surfaces of work surface 24. The milled surface can comprise a surface from which paving material has been completely removed or a surface of paving material from which an upper-most layer of paving material has been removed, or a surface comprising material mixed by milling assembly 20. In rotary mixers, rear transportation devices 16 can roll over mixed or reconstituted material and can be at the same level as front transportation devise 16.

Cold planer machine 10 can be configured to travel in a forward direction (from left to right with reference to FIG. 1) to remove work surface 24. Anti-slabbing system 34 can travel over the top of work surface 24 to prevent or inhibit work surface 24 from becoming prematurely dislodged during operations for removal of work surface 24. Rotor 22 can follow behind anti-slabbing system 34 to engage work surface 24. Rotor 22 can be configured to rotate counter-clockwise with reference to FIG. 1 such that material of work surface 24 can be uplifted and broken up into small pieces by cutting teeth or chisels of rotor 22. Anti-slabbing system 34 can be configured to contain pieces of work surface 24 within drum housing 28. Removed pieces of work surface 24 can be pushed up primary conveyor 40A and carried forward, such as by an endless belt, to secondary conveyor 40B. Secondary conveyor 40B, which can also include an endless belt, can be cantilevered forward of front frame end 12A to be positioned over a collection vessel, such as the box of a dump truck.

During the course of moving over work surface 24, either with rotor 22 engaging work surface 24 in an operating mode or with rotor 22 retracted to a transport or ride control mode, transportation devices 16 can encounter obstacles, such as depressions or protrusions, which can be rolled over by transportation devices 16. Such obstacles can cause rods or pistons of lifting columns 18 to be pushed inward into a cylinder of lifting columns 18 or to extend further outward from the cylinder, as the hydraulic system operates to redistribute hydraulic fluid within the system to each cylinder. Because, for example, the hydraulic system cannot redistribute hydraulic fluid fast enough or is not configured to redistribute hydraulic fluid at all, sometimes these movements can be jarring to an operator of cold planer machine 10, such as those disposed on operator platform 30, or can potentially interfere with a cut being produced by rotor 22. In a transport mode, e.g., a ride control mode, where rotor 22 is raised from work surface 24 and cold planer machine 10 is being driven at a higher speed, relative to a speed at which milling is typically conducted, to a different location to perform milling or to be loaded onto a truck for transportation, these movements can be particularly jarring.

The present application is directed to systems and methods for monitoring and controlling movements of lifting columns 18 to, for example, reduce operator discomfort by reducing jarring or sudden movements of lifting columns 18, maintain orientation of frame 12, and maintain desired cut characteristics of rotor 22. In particular examples, intermediate elements, such as free-floating pistons, gas-compressing pistons and dual-diameter cylinder devices, and fluid flow control valve systems, can be used to maintain or alter orientation of frame 12 and cold planer machine 10 by any one or more of manual operator interaction, automatic operation of control system 200 (FIG. 8) or automatic hydraulic operation of a hydraulic system to adjust one or more of lifting columns 18.

FIG. 2 is a diagrammatic top view of front left transportation device 16A, front right transportation device 16B, rear left transportation device 16C and rear right transportation device 16D connected to lifting columns 18A-18D, respectively, that are operatively connected to a hydraulic system comprising flow control devices 50A, 50B, 50C and 50D and fluid lines 52A, 52B, 52C, 52D, 52E, 52F, 52G and 52H.

As discussed, transportation devices 16A-16D allow movement of frame 12 in forward and backward directions. Each of transportation device 16A-16D can be coupled to an actuating member, such as one of lifting columns 18A-18D, that can permit a height adjustment of the respective transportation device 16A-16D, such as relative to frame 12 (FIG. 1). Lifting columns 18A-18D can comprise hydraulic cylinders including cylinders 54A-54D, pistons 56A-56D and rods 58A-58D. Rods 58A-58D can extend from cylinders 54A-54D, respectively, to couple to transportation device 16A-16D. The coupling between transportation device 16A-16D and lifting columns 18A-18D is simplified in FIG. 2.

In the embodiment illustrated, lifting columns 18A-18D are designed as hydraulic working cylinders, all the working cylinders being identical in terms of their construction and their dimensions in the exemplary embodiment. However, an arrangement of working cylinders of different piston diameters is also possible.

Lifting columns 18A-18D are designed as double-acting working cylinders, so that lifting columns 18A-18D have in each case a piston-side first working chamber 60A-60D and a piston rod-side second working chamber 62A 62D, respectively, which are separated from one another by pistons 56A-56D located in the cylinders 54A-54D. First and the second working chambers 60A 60D and 62A-62D can be filled with a pressure medium, which can be for example a hydraulic fluid or oil. Filling of first working chambers 60A-60D or an emptying of second working chamber 62A-62D causes a lowering of the associated transportation device 16A-16D (e.g., becoming closer to frame 12), while the filling of the second working chamber 62A-62D or the emptying of the first working chamber 60A-60D causes a raising of transportation device 16A-16D (e.g., becoming further away from frame 12).

Lifting columns 18A-18D can be indirectly connected to one another via fluid lines 52A-52H. Lifting column 18A can be indirectly connected to lifting column 18B via fluid lines 52A and 52B. Lifting column 18B can be indirectly connected to lifting column 18C via fluid lines 52C and 52D. Lifting column 18C can be indirectly connected to lifting column 18D via fluid lines 52E and 52F. Lifting column 18D can be indirectly connected to lifting column 18A via fluid lines 52G and 52H. Direct connection of lifting columns 18A-18D can be interrupted by flow control devices 50A-50D. However, flow control devices 50A-50D can permit power from one lifting column to another lifting column by maintaining pressurized engagements.

Flow control devices 50A-50D can be positioned to indirectly couple select fluid lines 52A-52H to prevent flow of the hydraulic fluid between lifting columns 18A-18D, but that facilitate power transfer therethrough. Flow control device 50A can indirectly connect fluid lines 52A and 52B. Flow control device 50B can indirectly connect fluid lines 52C and 52D. Flow control device 50C can indirectly connect fluid lines 52E and 52F. Flow control device 50D can indirectly connect fluid lines 52G and 52H. Flow control devices 50A-50D can comprise cylinders 66A-66D, pistons 68A-68D, first cylinder spaces 70A-70D and second cylinder spaces 72A-72D, respectively.

Fluid line 52A connects first working chamber 60A of lifting column 18A to second cylinder space 72A of flow control device 50A. Fluid line 52B connects first cylinder space 70A of flow control device 50A to first cylinder space 60B of lifting column 18B. Fluid line 52C connects second working chamber 62B of lifting column 18B to second cylinder space 72B of flow control device 50B. Fluid line 52D connects first cylinder space 70B of flow control device 50B to second cylinder space 62D of lifting column 18D. Fluid line 52E connects first working chamber 60D of lifting column 18D to second cylinder space 72C of flow control device 50C. Fluid line 52F connects first cylinder space 70C of flow control device 50C to first cylinder space 60C of lifting column 18C. Fluid line 52G connects second working chamber 62C of lifting column 18C to second cylinder space 72D of flow control device 50D. Fluid line 52H connects first cylinder space 70D of flow control device 50D to second cylinder space 62A of lifting column 18A.

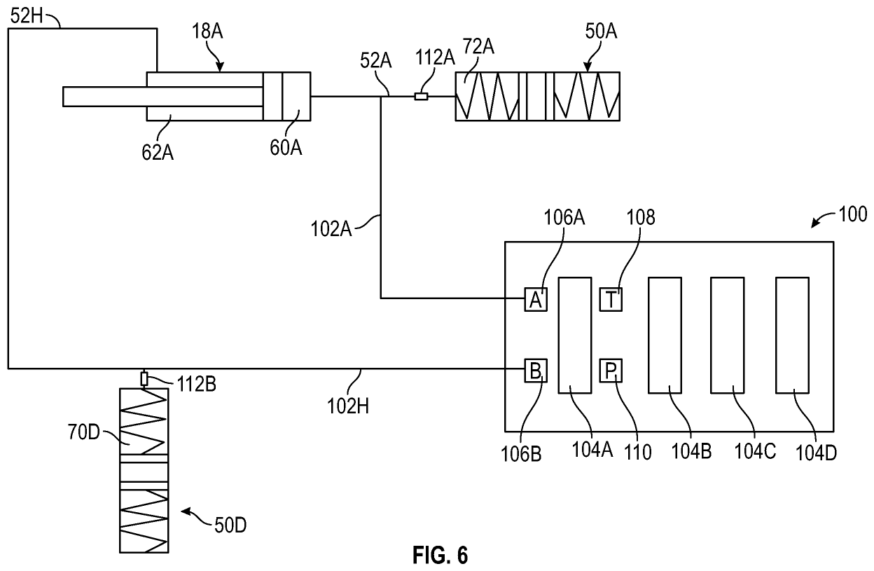

Working chambers 60A-60D and 62A-62D and cylinder spaces 70A-70D and 72A-72D form, together with fluid lines 52A-52H, a closed system having multiple closed sub-systems. In an example, as illustrated, the closed system comprises eight lengths of fluid passages connected end to end in series that each form a closed sub-system that does not exchange hydraulic fluid with any other sub-system. Although, other configurations are possible. For example, FIG. 6 shows control valve system 100 that permits fluid from each lifting columns 18A-18D to be controlled in each chamber 60A-60D and 62A-62D, respectively, thereby producing four closed fluid sub-systems.

As cold planer machine 10 drives, for example, with the left front transportation device 16A of frame 12, over an obstacle of, for example, a height of a give length, lifting column 18A can be retracted (e.g., rod 58A can be pushed into cylinder 54A) a proportion of that given length based on the weight of machine 10 and/or other factors. The hydraulic fluid can accordingly be pushed out of first working chamber 60A via fluid line 52A toward flow control device 50A, thereby pushing piston 68A to enlarge cylinder space 72A and shrink cylinder space 70A.

In reaction to this, hydraulic fluid in cylinder space 70A can be pushed through hydraulic line 52B into first working chamber 60B of lifting column 18B via fluid line 52B, causing working chamber 60B to expand. Piston 56B can push hydraulic fluid out of second working chamber 62B and into cylinder space 72B of flow control device 50B via fluid line 52C. Piston 56B additionally pushes rod 58B out of cylinder 54B such that the length of rod 58B outside of cylinder 54B increases.

In reaction to this, hydraulic fluid in second working cylinder 62B of lifting column 18B can be pushed toward flow control device 50B via fluid line 52C, thereby causing cylinder space 72B to enlarge and cylinder space 70B to shrink by operation of piston 68B.

In reaction to this, hydraulic fluid in cylinder space 70B can be pushed through hydraulic line 52D into second working chamber 62D of lifting column 18D via fluid line 52D, causing working chamber 62D to expand. Piston 56D can push hydraulic fluid out of first working chamber 60D and into cylinder space 72C of flow control device 50C via fluid line 52E. Piston 56D additionally pulls rod 58D into cylinder 54D such that the length of rod 58D outside of cylinder 54D decreases.

In reaction to this, hydraulic fluid in first working cylinder 60D of lifting column 18D can be pushed toward flow control device 50C via fluid line 52E, thereby causing cylinder space 72C to enlarge and cylinder space 70C to shrink by operation of piston 68C.

In reaction to this, hydraulic fluid in cylinder space 70C can be pushed through hydraulic line 52F into first working chamber 60C of lifting column 18C via fluid line 52F, causing working chamber 60C to expand. Piston 56C can push hydraulic fluid out of second working chamber 62C and into cylinder space 72D of flow control device 50D via fluid line 52G. Piston 56C additionally pushes rod 58C out of cylinder 54C such that the length of rod 58C outside of cylinder 54C increases.

In reaction to this, hydraulic fluid in second working cylinder 62C of lifting column 18C can be pushed toward flow control device 50D via fluid line 52G, thereby causing cylinder space 72D to enlarge and cylinder space 70D to shrink by operation of piston 68D.

In reaction to this, hydraulic fluid in cylinder space 70D can be pushed through hydraulic line 52H into second working chamber 62A of lifting column 18A via fluid line 52H. As such, working chamber 62A can receive hydraulic fluid to fill in the expansion of working chamber 62A caused by engagement of transportation device 16A with the obstacle. Thus, the amount that piston 58A gets pushed into cylinder 54A by the obstacle can cause piston 58B to be pushed out of cylinder 54B, piston 58C to be pushed out of cylinder 54C, and piston 58B to be pushed into cylinder 54B a proportional amount via hydraulic action.

It may be noted that, in examples, rods 58A-58D are moved a distance that is only a proportion of the height of the obstacle, assuming it is within the available stroke of cylinder 54A-54D for each of rods 58A-58D, respectively, with the result that the driving comfort of the operator of cold planer machine 10 and stability of cold planer machine 10 are improved. Pistons 68A-68D can comprise intermediate bodies of intermediate elements to manage flow of hydraulic fluid between lifting columns 18A-18C. Pistons 68A-68D can be configured to float to equalize pressure on either side of pistons 68A-68D in cylinder spaces 70A-70D and 72A-72D, respectively.

FIG. 3 is a diagrammatic top view of front left transportation device 16A, front right transportation device 16B, rear left transportation device 16C and rear right transportation device 16D connected to lifting columns 18A-18D, respectively, that are operatively connected to a hydraulic system comprising flow control devices 50A, 50B, 50C and 50D and fluid lines 52A, 52B, 52C, 52D, 52E, 52F, 52G and 52H.

Flow control devices 50A, 50B, 50C and 50D can include similar components as flow control devices 50A-50D as described with reference to FIG. 2 with the exception that pistons 68A-68D are replaced with double-piston assemblies comprising pistons 76A-76D and 78A-78D, between which are disposed compressible fluid 80A-80D, respectively. Flow control devices 50A, 50B, 50C and 50D of FIG. 3 operate in a similar manner as is described with reference to FIG. 2 except that rather than pistons 68A-68D simply being pushed or pulled depending on fluid levels in cylinder spaces 70A-70D and 72A-72D, pistons 76A-76D and 78A-78D can move relative to each other within cylinders 66A-66D, respectively, based on fluid levels and pressures within cylinder spaces 70A-70D and 72A-72D. In particular, compressible fluid 80A-80D, which can comprise a compressible gas, can compress as fluid enters one side of cylinder spaces 70A-70D and 72A-72D and leaves another. The compression of the gas can dampen or delay pressure of hydraulic fluid from one lifting column affecting pressure of hydraulic fluid or an adjacent lifting column. However, as the individual hydraulic fluid circuits engaging lifting columns 18A-18D levels out and reach equilibrium, the space between pistons 76A-76D and 78A-78D, respectively, can additionally reach equilibrium such that the distances that rods 58A-58D are extended or retracted can further reach equilibrium.

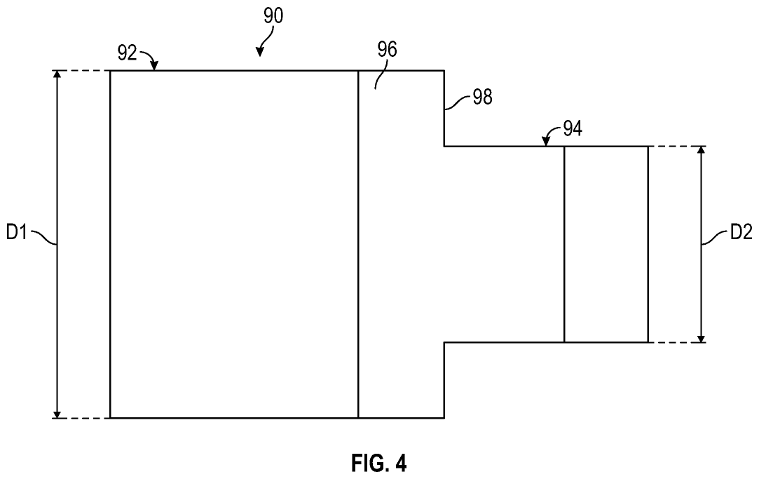

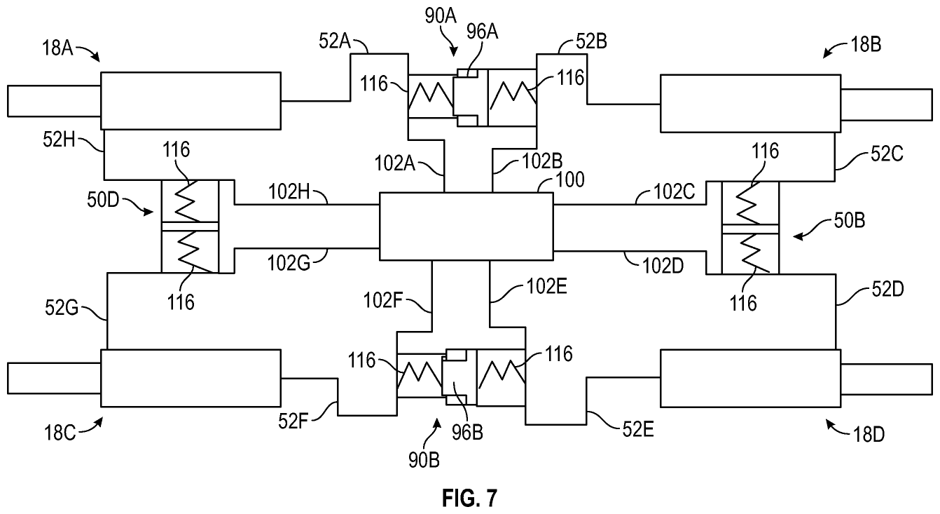

FIG. 4 is a diagrammatic view intermediate element 90 for use in a fluid line indirectly connecting two lifting columns. Intermediate element 90 can comprise first coupler 92, second coupler 94, piston 96 and end wall 98. In examples, intermediate element 90, such as is shown in FIG. 7, can be used in a plurality of places to replace intermediate elements 50A-50D of FIGS. 2 and 3 to connect fluid lines 52A-52H to balance the ride control system. In examples, intermediate element 90 can be a dual-diameter cylindrical device that can be used to couple fluid lines 52A and 52B. Coupler 92 can have diameter D1 and coupler 94 can have diameter D2. Additionally, in the embodiment of FIGS. and 7, fluid line 52A can have diameter D1 and fluid line 52B can have diameter D2, or compatible diameters to sealingly mate with couplers 92 and 94, respectively. The entire length of fluid line 52B from lifting column 18A to intermediate element 90 can have diameter D1. The entire length of fluid line 52A from intermediate element 90 to lifting column 18B can have diameter D2. Diameter D1 can be larger than diameter D2. Piston 92 can be located in coupler 92 and 94 and can have a diameter configured to sealingly engage with the inner diameter of coupler 92. As such, intermediate element 90 can be used to directionally control flow depending on which way piston 96 is travelling. Note, the location of piston 96 within coupler 92 is shown for illustrated purposes. The exact position of piston 96 would change depending on the configuration of intermediate element 90 and the system attached thereto.

If fluid were moving into coupler 92 from fluid line 52A, piston would be forced to move to the right with reference to FIG. 4. Because diameter D1 is larger than diameter D2, intermediate device can act as a multiplier, as the relatively larger volume of hydraulic fluid located on the right side of piston 96 (given the configuration of FIG. 4) is forcing the a smaller volume within coupler 94. If fluid were moving into coupler 94 from fluid line 52B, piston would be forced to move to the left with reference to FIG. 4. Because diameter D2 is smaller than diameter D1, intermediate device can act as a force and flow manipulator, as the relatively smaller volume of hydraulic fluid located in coupler 94 would be forced by the larger volume within coupler 92 on the right side of piston 96. As such, depending on the orientation of intermediate element 90, transfer of power between a plurality of closed hydraulic fluid sub-system can be selectively controlled, such as by adding or subtracting hydraulic fluid from different fluid lines 52A-52H and storing said fluid within intermediate element 90, thereby selectively controlling the individual height adjustment of lifting columns 18A-18D connected thereto.

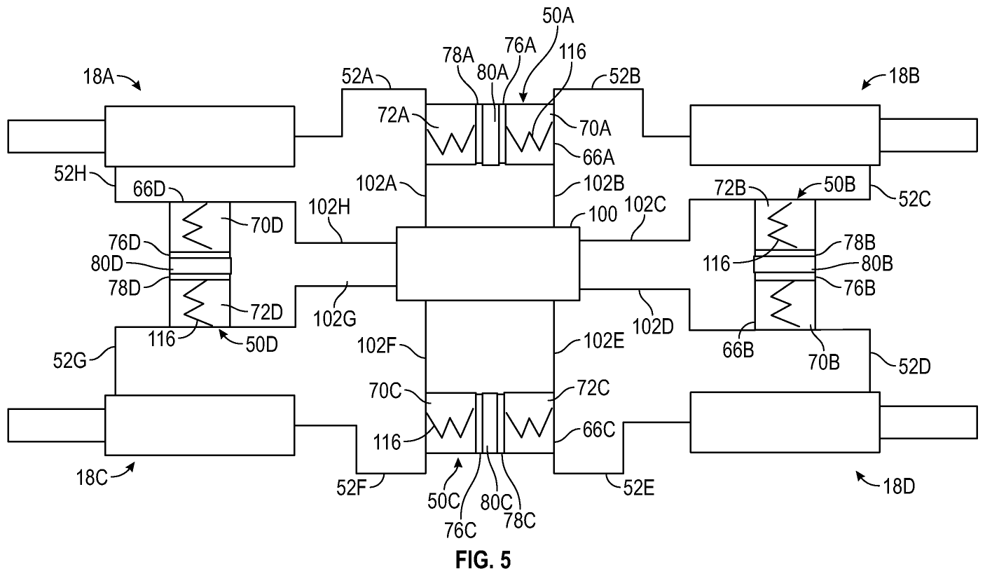

FIG. 5 is a diagrammatic top view of front left transportation device 16A, front right transportation device 16B, rear left transportation device 16C and rear right transportation device 16D connected to lifting columns 18A-18D, respectively, that are operatively connected to a hydraulic system including fluid lines 52A-52D, flow control devices 50A-50D, comprising gas-compressing pistons of FIG. 3, and control valve system 100 for fluidly connecting ends of individual lifting columns 18A-18D while maintaining isolation between lifting columns 18A-18D. Control valve system 100 can be individually fluidly coupled to flow control device 50A via fluid lines 102A and 102B, flow control device 50B via fluid lines 102C and 102D, flow control device 50C via fluid lines 102E and 102F and flow control device 50D via fluid lines 102G and 102H. As discussed with reference to FIG. 6, control valve system 100 can include a valve and reservoir of auxiliary hydraulic fluid for each of cylinders 18A-18D.

As is described with reference to FIG. 3, flow control devices 50A, 50B, 50C and 50D can include double-piston assemblies comprising cylinders 66A-66D having pistons 76A-76D and 78A-78D, between which are disposed compressible fluid 80A-80D, respectively. Cylinder spaces 70A-70D and 72A-72D can be formed besides pistons 76A-76D.

Control valve system 100 can be configured to shift hydraulic fluid from an individual closed hydraulic fluid sub-systems on one side of each of lifting columns 18A-18D to the other side of each of lifting columns 18A-18D, respectively. In an example, control valve system 100 can shift fluid from one of working chambers 60A-60D to one of working chambers 62A-62D (see FIG. 2, for example), respectively, within a single lifting column 18A-18D. Control valve system 100 can be configured with, for example, four individually controllable valve elements (e.g., valve elements 104A-104D of FIG. 6) to control flow between subsets of lines 102A-102H. Control valve system 100 can be coupled to control system 200 of FIG. 8 for control of valve elements 104A-104D. In examples, control valve system 100 can comprise a mechanical, pressure balanced valve system that can redistribute hydraulic fluid within the individual hydraulic sub-systems based on, for example, pressure within cylinder spaces 70A-70D. As such, flow control devices 50A-50D can include springs 116. Valve elements 104A-104D can be configured to control flow through fluid lines 102A-102H. As discussed herein, control valve system 100 can be configured to isolate fluid lines 52A-52H into paired segments (52A and 52H; 52B and 52C; 52G and 52F and 52D and 52E) to, for example, better control pressure transmission of fluid through the hydraulic system for ride control smoothness, isolate contamination and facilitate maintenance on subsections of the hydraulic system.

Control system 200 (FIG. 8) can be in communication with control valve system 100 and valves 112A and 112B to perform pressure balancing operations, to permit hydraulic fluid within one cylinder to flow to a flow control device to balance an machine and pressure for the purposes of Ride Control. For example, if front left propulsion device 16A connected to lifting column 18A impacts an object, such as a rock or a curb, hydraulic fluid can be pushed into cylinder space 72A. Control valve system 100 and valves 112A and 112B can be operated to direct or block fluid from cylinder space 72A, for example, cylinder space 70D of flow control device 50D (using valves 104A-104D) so that only lifting column 18A is affected. Specifically, hydraulic fluid for operating lifting column 18A is not introduced into or mixed with hydraulic fluid for operating any of lifting columns 18B-18C.

As mentioned, control valve system 100 can be configured, in a grade and slope mode, to direct hydraulic fluid to any location in the hydraulic system in reaction to one or more of transportation devices 16A-16D impacting an object or traversing a depression. However, control valve 100 for grade and slope can be disabled, or otherwise not operational for grade and slope, during a ride control mode. Control valve system 100 can be configured so that hydraulic fluid is only shared between certain portions or sub-systems of the hydraulic system such that each of lifting columns 18A-18D can be fluidly isolated from each of the other of lifting columns 18A-18D to, for example, prevent contamination spread and facilitate greater resolution over the control of hydraulic fluid within the hydraulic system.

FIG. 6 is a diagrammatic view of an example of control valve system 100 of FIG. 5 wherein control valve system 100 is configured to control fluid flow between ends of individual lifting columns 18A-18D. In examples, control valve system 100 can comprise valves 104A-104D, which can comprise a plurality of 4-way control valves. In examples, control valve system 100 can comprise four proportional 4-way, 3-position valves. In additional configurations, control valve system 100 can comprise three valves.

As shown in FIG. 6, valve 104A can connect fluid line 102A and fluid line 102H to thereby connect fluid line 52A to fluid line 52H, which in turns fluidly links working chamber 60A and cylinder space 72A with working chamber 62A and cylinder space 70D. First stop valve 112A and second stop valve 112B can be selectively actuated by a controller, e.g., controller 232 of FIG. 8, to permit and inhibit flow into flow control devices 50A and 50D, respectively.

Although omitted from FIG. 6 for simplicity valves 104B-104D can be similarly configured. Thus, with combined reference to FIGS. 2 and 6, valve 104B can connect fluid line 102B and fluid line 102C to thereby connect fluid line 52B to fluid line 52C, which in turns fluidly links working chamber 60B and cylinder space 70A with working chamber 62A and cylinder space 72B; valve 104C can connect fluid line 102G and fluid line 102F to thereby connect fluid line 52G to fluid line 52F, which in turns fluidly links working chamber 62C and cylinder space 72D with working chamber 60C and cylinder space 70C; and valve 104D can connect fluid line 102D and fluid line 102E to thereby connect fluid line 52D to fluid line 52E, which in turns fluidly links working chamber 60D and cylinder space 72C with working chamber 62D and cylinder space 70B.

Valve 104A can comprise first input port 106A, second input port 106B, to which tank 108 and pressure source 110 can be selectively coupled via operation of valve 104A. That is fluid line 102A and fluid line 102H can be closed by valve 104A or opened to either of tank 108 and pressure source 110. Tank 108 can comprise a reservoir or volume of unpressurized hydraulic fluid. Pressure source 110 can comprise any source of pressurized hydraulic fluid. Tank 108 and pressure source 110 for valve 104A can be separate from tanks and pressure sources for valves 104B-104C.

FIG. 7 is a diagrammatic top view of front left transportation device 16A, front right transportation device 16B, rear left transportation device 16C and rear right transportation device 16D connected to lifting columns 18A-18D, respectively, that are operatively connected to a hydraulic system including fluid lines 52A-52H, intermediate elements 90A and 90B, comprising gas-compressing pistons of FIG. 3, and control valve system 100 fluidly connecting various ends of the lifting columns 18A-18D. Intermediate elements 90A and 90B can be configured as intermediate element 90 of FIG. 4. Control valve system 100 can be configured in any manner as described herein, such as with respect to FIGS. 5 and 6. Control element 90A can positioned to control hydraulic fluid flow between front left lifting column 18A and front right lifting column 18B, and control element 90B can positioned to control hydraulic fluid flow between rear left lifting column 18C and rear right lifting column 18D. Meanwhile, flow control devices 50D and 50B can be used to control hydraulic fluid flow between front left lifting column 18A and rear left lifting column 18C and front right lifting column 18B and rear right lifting column 18D, respectively. Such a configuration can be well-suited for controlling forward-aft or transverse tilting of frame 12 during ride control operations. In additional examples, control elements 90A and 90B can be substituted for control devices 50B and 50D and control elements 90A and 90B can be replaced by control devices 50A and 50C (FIG. 2). In additional examples, control devices 50B and 50D can be replaced by control elements similar to control elements 90A and 90B.

FIG. 8 is an illustration of control system 200 for cold planer machine 10. Control of cold planer machine 10 can be managed by one or more embedded or integrated controllers 232 of cold planer machine 10. Controller 232 can comprise one or more processors, microprocessors, microcontrollers, electronic control modules (ECMs), electronic control units (ECUs), programmable logic controller (PLC) or any other suitable means for electronically controlling functionality of cold planer machine 10.

Controller 232 can be configured to operate according to a predetermined algorithm or set of instructions for controlling cold planer machine 10 based on various operating conditions of cold planer machine 10, such as can be determined from output of various sensors included in sensor system 222, slope sensor 212 and auxiliary sensor(s) 214, as well as control valve system 100. Sensor system 222 can include position sensor, angle sensors, current sensors, proximity switches and the like. Such an algorithm or set of instructions can be stored in database 234, can be read into an on-board memory of controller 232, or preprogrammed onto a storage medium or memory accessible by controller 232, for example, in the form of a floppy disk, hard drive, optical medium, random access memory (RAM), read-only memory (ROM), or any other suitable computer readable storage medium commonly used in the art (each referred to as a “database”), which can be in the form of a physical, non-transitory storage medium.

Controller 232 can be in electrical communication or connected to drive assembly 236, or the like, and various other components, systems or sub-systems of cold planer machine 10. Drive assembly 236 can comprise an engine, a hydraulic motor, a hydraulic system including various pumps, reservoirs and actuators, among other elements (such as power source 14 of FIG. 1). By way of such connection, controller 232 can receive data pertaining to the current operating parameters of cold planer machine 10 from sensors, such as position sensors of sensor system 222, slope sensor 212, sideplate sensors 240, and the like. In response to such input, controller 232 can perform various determinations and transmit output signals corresponding to the results of such determinations or corresponding to actions that need to be performed, such as for producing forward and rearward movement using ground engaging units 216 (such as transportation devices 16 of FIG. 1) or producing up and down movements of lifting columns 18.

Controller 232, including operator interface 238, can include various output devices, such as screens, video displays, monitors and the like that can be used to display information, warnings, data, such as text, numbers, graphics, icons and the like, regarding the status of cold planer machine 10. Controller 232, including operator interface 238, can additionally include a plurality of input interfaces for receiving information and command signals from various switches and sensors associated with cold planer machine 10 and a plurality of output interfaces for sending control signals to various actuators associated with cold planer machine 10. Suitably programmed, controller 232 can serve many additional similar or wholly disparate functions as is well-known in the art.

With regard to input, controller 232 can receive signals or data from operator interface 238 (such as at control panel 32 of FIG. 1), position sensors of sensor system 222, sideplate sensors 240, and the like. As can be seen in the example illustrated in FIG. 8, controller 232 can receive signals from operator interface 238. Such signals received by controller 232 from operator interface 238 can include, but are not limited to, an all-leg raise signal and an all-leg lower signal for lifting columns 18. In some embodiments, front legs 218 (such as lifting columns 18 of FIG. 1) can be controlled individually directly, while rear legs 218 (such as lifting columns 18 of FIG. 1) are controlled together indirectly based off movements of the front legs.

Controller 232 can also receive position and/or length data from each position sensor of sensor system 222, or any other suitable sensor that can provide output from which position or length data can be determined, such as a current sensor or flow sensor. As noted before, such data can include, but is not limited to, information as to the lengths of legs 218 or the amount of extension or retraction of the leg 218. Such information can be used to determine an orientation of frame 12 relative to propulsors 16.

Controller 232 can also receive data from one or more sideplate sensors 240. Such data can include, but is not limited to, information related to the vertical position of sideplates 224 (e.g., sideplates 24 of FIG. 1) and/or whether sideplates 224 are in contact with the top of work surface 24 of FIG. 1. Such data can also be used to determine a difference in the height of work surface 24 on either side of rotor 22 (FIG. 1)

Controller 232 can receive data from position sensors or sensor system 222 and other sensors such as auxiliary sensor(s) 214, which may comprise GNSS sensors, as discussed below. Such data can include, but is not limited to, information related to latitudinal and longitudinal location of machine 10, the altitude of machine 10, the velocity and acceleration of machine 10, and the bearing or heading of machine 10. Such information can be used to four-dimensionally map data of machine 10 in time and space. Furthermore, such data can be used to determine the orientation of frame 12 to, for example, perform ride control operations of machine 10, e.g. operations of machine 10 when rotor 22 is disengaged, to maintain safe and comfortable operation of machine 10.

Controller 232 can also receive data from other controllers, grade and slope system 242 for cold planer machine 10, operator interface 238, and the like. In examples, another controller can provide information to controller 232 regarding the operational status of cold planer machine 10. In other examples, such information can be provided by grade and slope system 242, a hydraulic system controller or the like, to controller 232. The operation status received can include whether cold planer machine 10 is in non-milling operational status or milling operational status (e.g., rotor 22 is not spinning or rotor 22 is spinning). In examples, grade and slope system 242 can receive and process data from operator interface 238 related to the operator desired depth of the cut, the slope of the cut, and the like. Grade and slope system 242 can comprise one or more auxiliary sensors 214 and slope sensor 212. Controller 232 can receive information from system management and inputs like valve current, hydraulic fluid flow and track angle sensors, for example, but are not limited to the specific listed examples.

In examples, slope sensor 212 can comprise a sensor configured to sense the longitudinal (e.g., front-to-back) and transverse (e.g., left-to-right) orientations of frame 12. Slope sensor 212 can be positioned near the longitudinal and lateral center of frame 12 and can be configured to generate a signal indicative of the slope of cold planer machine 10. The slope of cold planer machine 10 can be defined with respect to a movement of frame 12 about a longitudinal axis LA, which can be coincident with axis A of FIG. 1, extending in a direction of travel of machine 10, and a transverse axis TA extending left-to-right across machine 10 perpendicular to longitudinal axis LA. The slope of cold planer machine 10 can be defined with respect to a movement of cold planer machine 10 and with respect to a horizontal reference plane perpendicular to a direction of a gravitational force F of cold planer machine 10. The gravitational force F can correspond to a force caused by a weight of cold planer machine 10 at a center of gravity CG thereof towards the ground surface 202.

Slope sensor 212 can be configured to generate signals indicative of rotational attributes of cold planer machine 10, such as a pitch and a roll. The pitch can correspond to the movement of cold planer machine 10 about the transverse axis TA and the roll can correspond to the movement of cold planer machine 10 about the longitudinal axis LA. In various examples, slope sensor 212 can include a sensor device, an angle measurement device, a force balancing member, a solid state member, a fluid filled device, an accelerometer, a tilt switch, gyro or any other device that can determine the slope of cold planer machine 10 with respect to one or more of the various reference parameters including, but not limited to, the longitudinal axis LA and the transverse axis TA of cold planer machine 10, the reference plane and the ground surface 102.

In examples, auxiliary sensor(s) 214 can comprise additional slope sensors, global navigation satellite system (GNSS) sensors, or other sensor for determining data regarding the operation or position of machine 10.

System 200 can be configured to adjust the position and orientation of frame 12 based on input from one or a combination of various sources, such as position sensors of sensor system 222 and control valve system 100.

In particular, controller 232 can be, in various examples, configured to detect changes in position of first end 12A and second end 12B of frame 12 based on input from position sensors 212 associated with a change in topography of the surface over which cold planer machine 10 is traversing, such as surface 24. In examples, the orientation of frame 12 can be determined using only position sensors 212 without input from slope sensors 212. For example, as one of transportation devices 16 engages a protrusion in surface 24 or a depression in surface 24, an associated position spike or position drop, respectively, can occur at first end 12A or second end 12B. Controller 232 can, in response to a sudden altitude change at one of ends 12A and 12B cause one or more lifting columns 18 to change height, such as by inducing a hydraulic fluid volume change in one of more of hydraulic cylinders associated with lifting columns 18, to return frame 12 to a desired orientation, such as by using control valve system 100. Additionally, an operator of cold planer machine 10 can manually receive information from controller 232, such as via operator interface 238, and manually adjust the height of lifting columns 18.

Controller 232 can further be configured to be in communication with a hydraulic system controlling operation and position of lifting columns 18, such as those shown in FIGS. 2, 3, 5 and 7. In examples, the hydraulic system can be configured according to the disclosure of Pub. No. US 2007/0098494 A1 to Mares, which is hereby incorporated in its entirety by this reference. In examples, the hydraulic system can include a reservoir for containing a hydraulic fluid and one or more pumps to communicate the hydraulic fluid with lifting columns 18 and transportation devices 16. One or more direction control valves can be disposed in the hydraulic system to control direction of flow of the hydraulic fluid. Furthermore, additional control valves, such as check valves, pressure relief valves, pressure regulating valves, and the like can be disposed in the hydraulic system for generating required hydraulic power for actuation of the transportation devices 16 and lifting columns 18. Controller 232 can be in communication with the one or more directional control valves and one or more additional control valves to control the flow of the hydraulic fluid to each of transportation devices 16 and lifting columns 18. Thus, the hydraulic system in communication with controller 232 can be configured to actuate each of the transportation devices 16 and lifting columns 18 individually or in various combinations and sub-combinations based on one or more inputs received from controller 232. Likewise, control panel 32 can include operator inputs to control the hydraulic system through controller 232. Additionally, the hydraulic system or a separate hydraulic system can be in communication with transportation devices 16 to provide hydraulic fluid for motive force for transportation devices 16 that can be additionally controlled by controller 232.

Controller 232 can be configured to adjust the position of lifting columns 18 to adjust the longitudinal and transverse slopes of frame 12 in order to maintain a desired orientation or attitude of frame 12 and cold planer machine 10. In examples, a desired orientation of frame 12 can be within a range of being parallel to or coextensive with the reference plane. In other words, the boundaries for frame 12 can be set within a predetermined set of constraints and controller 232 can be configured to maintain frame 12 so that the slopes do not exceed the set of constraints. In an example, such range can be +/−twenty-five degrees of being parallel to the reference plane. In an example, such range can be +/−fifteen degrees of being parallel to the reference plane. The reference plane can vary as machine 10 travels over different terrain. For example, if surface 24 is level, S1 and S2 will be zero. However, if surface 24 is sloped, one or both of the slopes will be non-zero. Such ranges can be determined based on knowledge of the terrain on which machine 10 is intended to operate, roll-over preventative measures programmed into controller 232, roll-over preventative means attached to frame 12 and the like. The present inventors have found that being within about twenty-five to fifteen degrees of parallel to frame 12 can provide a safe and smooth ride that is tolerable for an operator of machine 12, while reducing the potential for roll-over and not unduly limiting the ability of machine 10 to traverse uneven terrain. The selected tolerance band for the reference plane can be programmed into database 234. In examples, the tolerance band is factory-set and cannot be adjusted by an operator at operator interface 238. In other examples, the tolerance band can be selected, such as from a predetermined menu of suitable tolerance bands, at operator interface 238.

A desired orientation or attitude for frame 12 and cold planer machine 10 can be entered at operator interface 238 and stored in database 234 or a memory module of controller 232. As such, data from one or more of position sensors of sensor system 222, slope sensor 212 and auxiliary sensor(s) 214 can be used to determine the orientation of frame 12 and compared with an operator-input orientation. Then, information from position sensors of sensor system 222 can be used to adjust the position of lifting columns 18 to bring frame 12 back into, or within a tolerance band of, the operator-input orientation.

Controller 232 can be configured to actuate at least one of lifting columns 18 to raise or lower at least one of transportation devices 16. Controller 232 can communicate with the hydraulic system to extend or retract at least one of lifting columns 18 to reduce adjust first slope S1 and second slope S2. The selected legs to be actuated can be referred to as the actuatable leg(s). Controller 232 can actuate at least one of lifting columns 18 until the first slope S1 and the second slope are returned to the desired slope, e.g., within the predefined constraints.

Controller 232 can determine positions of lifting columns 18 with reference to frame 12. The position of each of lifting columns 18 can correspond to a position between the maximum extended position and the maximum retracted position thereof. Each of lifting columns 18 can be at various positions based on the slope of cold planer machine 10, such as is set by the operator at operator interface 238.

In an example, one or more of lifting columns 18 can be at the extended position or the retracted position, or between the extended position and the retracted position. Controller 232 can determine the positions of lifting columns 18 based on the signals received from the one or more position sensors of sensor system 222, and in some cases, auxiliary sensor 214 and slope sensor 212. Controller 232 can also communicate with the hydraulic system to determine the position of lifting columns 18. Controller 232 can actuate lifting columns 18 based on the positions of lifting columns 18 and the slopes of cold planer machine 10. In examples, if one of lifting columns 18 is in a fully extended position, then such lifting column cannot extend further to control the slopes. Similarly, if one of lifting columns 18 is in a fully retracted position, then such lifting column cannot retract further to control the slopes. Controller 232 can actuate at least one of or all of lifting columns 18 based on the positions of each of lifting columns 18 to control the slopes. In an example, if machine 10 is traversing an undulation wherein one of propulsors 16 enters a depression, controller 232 can operate to extend the lifting column 18 connected to that propulsor 16. Additionally, controller 232 can operate to simultaneously retract another of lifting columns 18 in order to, for example, reallocate distribution of hydraulic fluid within a hydraulic system operating lifting columns 18. For example, if the front left propulsor 16 enters a depression, the front right propulsor can be retracted, thereby lowering first end 12A of frame relative to second end 12B. However, controller 232 can maintain the overall orientation of frame 12 within the desired tolerance band relative to the reference plane. Alternatively, only one of extending and retracting different propulsors can be conducted with an accumulator in the hydraulic system being used, if beneficial.

### INDUSTRIAL APPLICABILITY

The present application describes various systems and methods for controlling vertical movement of machines including individually mounted propulsion elements or transportation devices. The propulsion elements or transportation devices can be mounted to lifting columns, such as hydraulic cylinders, that can be controlled with a hydraulic system. For example, four hydraulic cylinders of a propulsion system can be indirectly connected to each other, either in a closed-loop manner or by four individual segments connecting adjacent hydraulic cylinders in series. Intermediate elements can be fluidly positioned between fluidly adjacent hydraulic cylinders. The intermediate elements can smooth out sudden hydraulic fluid adjustments between adjacent cylinders so that, for example, an operator of a milling machine feels a smoother ride. In various examples, the intermediate elements can comprise free floating pistons in double-sided fluid cylinders, double-piston cylinders including a compressible gas media between the pistons, or a cylinder unit with differing bore sizes. Furthermore, individually closed or segregated hydraulic fluid segments produced by the intermediate elements described herein can assist in preventing contaminated hydraulic fluid from spreading throughout the entire hydraulic system and can facilitate easier maintenance of the hydraulic system by allowing individual segments to be serviced without draining the entire hydraulic system.

What is claimed is:

1. A hydraulic circuit for a lifting system of a propulsion system for a construction machine having multiple independent propulsors, the hydraulic circuit comprising:
a plurality of hydraulic cylinders each comprising a piston and a rod for coupling to a propulsor;
a plurality of fluid lines coupling each of the plurality of hydraulic cylinders in series, wherein movement of one piston hydraulically causes movement of a subsequent piston in an opposite direction; and
a plurality of flow control devices positioned within the plurality of fluid lines such that a flow control device is positioned between adjacent hydraulic cylinders, each flow control device comprising an intermediate body configured to smooth flow of hydraulic fluid between adjacent hydraulic cylinders without directly coupling one cylinder to another.

2. The hydraulic circuit of claim 1, wherein each flow control device comprises a cylinder and the intermediate body comprises a free-floating piston in each cylinder.

3. The hydraulic circuit of claim 1, wherein each flow control device comprises a cylinder and the intermediate body comprises a double-piston assembly in each cylinder, the double-piston assembly comprising a pair of damping pistons between which is disposed a compressible medium.

4. The hydraulic circuit of claim 1, wherein each of the flow control devices comprises a dual-diameter cylinder comprising a first end portion having a first diameter and a second end portion having a second diameter smaller than the first diameter, and the intermediate body comprises a piston located in the first end portion and the second end portion.

5. The hydraulic circuit of claim 1, further comprising a control valve to control movement of individual hydraulic cylinders of the plurality of hydraulic cylinders.

6. The hydraulic circuit of claim 5, wherein the control valve controls flow of hydraulic fluid between opposite sides of a piston of a single hydraulic cylinder

7. The hydraulic circuit of claim 6, wherein the control valve comprises one or more proportional, 4-way, 3-position valves.

8. The hydraulic circuit of claim 5, further comprising:
a sensor system for defining a location for the rod of each hydraulic cylinder relative to the hydraulic cylinder; and
a controller configured to operate the control valve based on input from the sensor system.

9. The hydraulic circuit of claim 1, wherein the flow control devices divide the hydraulic circuit into a plurality of discrete, isolated segments.

10. The hydraulic circuit of claim 1, wherein at least one of the intermediate bodies of the plurality of flow control devices comprises a free-floating piston and another one of the intermediate bodies of the plurality of flow control devices comprises a duel-diameter cylinder piston.

11. A method of smoothing movement between adjacent hydraulic cylinders in a hydraulic circuit for a lifting system of a propulsion system for a construction machine having multiple independent propulsors, the method comprising:
displacing a first piston of a first hydraulic cylinder of the lifting system due to impacting an obstacle by a first propulsor coupled to the first hydraulic cylinder;
transferring force from a first hydraulic fluid from the first hydraulic cylinder in a first fluid line to a second hydraulic fluid of a second hydraulic cylinder in a second fluid line; and
smoothing force transfer between the first hydraulic cylinder and the second hydraulic cylinder with an intermediate body disposed between the first fluid line and the second fluid line.

12. The method of claim 11, wherein the intermediate body comprises a floating piston that drifts from closer to the first hydraulic cylinder to closer to the second hydraulic cylinder in reaction to the transferring of force from the first hydraulic fluid of the first hydraulic cylinder.

13. The method of claim 12, wherein the floating pistons of the intermediate bodies segregate hydraulic fluid between hydraulic cylinders.

14. The method of claim 11, wherein the intermediate body comprises a double-piston assembly that compresses a gas therebetween in reaction to the transferring of force between the first and second hydraulic fluids.

15. The method of claim 14, wherein compression of the gas dampens movement of the first and second hydraulic fluids in the hydraulic circuit.

16. The method of claim 11, wherein the intermediate body comprises a dual-diameter cylinder comprising a first end portion having a first diameter and a second end portion having a second diameter smaller than the first diameter, and a piston located in the first end portion.

17. The method of claim 16, wherein the dual-diameter cylinder acts as a hydraulic fluid multiplier for hydraulic fluid flow in a first direction through the hydraulic circuit.

18. The method of claim 17, wherein the dual-diameter cylinder acts as a hydraulic fluid accumulator for hydraulic fluid flow in a second direction through the hydraulic circuit opposite the first direction.

19. The method of claim 11, further comprising controlling hydraulic fluid flow between opposite sides of a piston of a single hydraulic cylinder using a control valve.

20. The method of claim 19, further comprising controlling the hydraulic fluid between opposite sides of the piston of the single hydraulic cylinder using a proportional, 4-way, 3-position valve.
